(19) United States
(12) Patent Application Publication
(10) Pub. No.: US 2002/0117489 A1
(43) Pub. Date: Aug. 29, 2002

(54) Method and system for hot wire welding

(76) Inventors: Tony Lee Arndt, Mooresville, NC (US); Roger Carl Dik, Cornelius, NC (US); Pellervo Johnnes Kaskinen, Huntersville, NC (US)

Correspondence Address: SMITH, GAMBRELL & RUSSELL, LLP, Suite 800, 1850 M Street, N.W., Washington, DC, 20036, US

(21) Appl. No.: 09/793,547

(22) Filed: Feb. 27, 2001

Related U.S. Application Data
(63) Continuation of application No. 09/790,713, filed on Feb. 23, 2001.

(51) Int. Cl. B23K 9/10

(52) U.S. Cl. 219/130.5; 219/75

(57) ABSTRACT

A hot wire welding method and system rely upon a welding torch with a non-melting electrode, a melting metal filler wire that is fed into a weld puddle created by welding arc, a microprocessor controller for controlling (i) current of the main welding arc, (ii) filler wire feed speed, and (iii) hot wire current for heating the filler wire. The method and system also rely upon a main welding power supply for supplying the main welding arc and a secondary DC supply for supplying the hot wire current. The hot wire current is automatically controlled by the microprocessor to supply the correct amount of current to the filler wire in response to changes in wire feed speed.

### BACKGROUND OF THE INVENTION

1. Field of the Invention

The present invention relates to hot wire welding. More specifically, the invention relates to a method and system for hot wire welding wherein control of the hot wire supply current is in direct relationship to the speed of the feed wire.

2. Description of the Prior Art

The basic theory of Hot Wire (vs. Cold Wire) is to preheat the filler wire by running an electric current through it. The term “Hot Wire” is used because it is electrically hot, as well as physically hot. This allows a much higher disposition rate than conventional Cold Wire. The difference between the Hot Wire and Cold Wire systems is not striking until high feed rates are used. Generally, this rate will be above 130 inches per minute (IPM) for 0.035″ wire or above 100 IPM for 0.045″ wire. Many variables are involved, but typically with a Hot Wire system the amount of filler material added to the weld can be 2 to 4 times that for Cold Wire systems.

With reference to FIG. 1, there is depicted a block diagram of a prior art manually controllable hot wire welding system wherein a hot wire voltage is manually adjusted to match the wire feed rate. This system has a main welding power supply 11, which supplies a main welding current to a torch 12. A hot wire power supply 14, is an AC supply, but can be a DC supply. This system applies the hot wire voltage to a welding wire 10 by means of a contact block 16. This prior art system supplies a constant voltage supply to the filler wire to provide wire preheating prior to entering a main welding puddle 17. A ground or work piece 13 provides a return path for both the main welding current and the hot wire current. A wire feed motor 15 feeds the wire 10 from a wire spool 9 into the welding puddle 17.

This prior art system does not provide coordinated control of components with respect to other components. Specifically, as an operator needs to increase the wire feed speed, and the operator must then manually adjust the hot wire voltage by use of a rheostat or control potentiometer. This operation raises the possibility of introducing many errors. For example, an excessively high hot wire voltage results in the burning back or premature melting of the wire within the wire feed conduit or nozzle; this causes damage to the feeding system. On the other hand, if there is insufficient hot wire voltage applied for a certain wire feed speed, the wire will not adequately melt into the weld puddle, and in some cases will shoot through the welding arc. In this prior art system, the correlation between the wire feed speed and the hot wire voltage control has to be a well-timed and well-planned in order to maintain a good welding cycle.

Another prior art problem is magnetic interference or “Arc Blow” caused by the AC voltage or high DC voltage applied to the filler wire by the constant voltage power source 14. Magnetic interference causes the main welding arc to wander and not maintain a consistent location at the desired welding position. To eliminate or minimize the effects of this problem, in some systems, the hot wire supply 14 is turned on only during the background current for the main welding arc. This requires pulsing of the main weld current. However, pulsing of the main weld current may not be ideal for the type of weld being done.

FIG. 2 is a block diagram of another prior art hot wire welding system, which includes a complex arrangement of measuring and sensing circuitry for measuring the hot wire voltage and current, and for operating a gate thyristor to turn on and off the hot wire supply voltage. This system employs some interaction control between the wire feed speed and the hot wire voltage supply. With reference to FIG. 2, there is provided a main welding current supply 21 that supplies welding current to a torch 22. A hot wire voltage supply 24 is connected to a filler wire 20 by means of a contact block 26, and to the ground or work piece 23. The filler wire is fed into the puddle 27 by a wire feed motor 25. By means of an array of measuring and sensing circuitry 27, the hot wire supply is controlled with respect to changes in the hot wire sense voltage at the welding puddle 27. As the hot wire is being fed into the welding puddle 27, the voltage that exists between the tip of the filler wire 10 and the work piece 23 is measured by the voltage sensing circuitry. The hot wire current is also routed through a Hall effect device, which measures the amount of hot wire current. Power is equal to voltage times current (P=VI). The result of the two measured values is routed through a comparator circuit, which compares this result to a desired input. The difference from this comparison is then used to drive the hot wire supply. As the wire is introduced into the puddle at faster speeds, the resulting hot wire voltage is decreased, and this reduces the amount of wire gap. As this happens, the hardware circuit attempts to increase the power output of the hot wire supply to maintain a constant voltage at the filler wire 10. As slower wire feed speeds are introduced, the resulting hot wire voltage is increased, due to the fact that the wire is going in the puddle slower; this increases the amount of wire gap. As this happens the hardware circuit 27 attempts to decrease the power output of the hot wire supply to maintain a constant voltage at the filler wire. This system also employs a control thyristor (GT) which allows the hot wire supply to be turned on during the presence of background current for the main welding arc.

Some of the problems associated with the prior art system of FIG. 2 results from the complexity of the measuring and sensing circuitry needed to attempt to maintain a constant hot wire voltage. This circuitry requires sensing leads to be mounted at the hot wire contact block 26, and the use of a Hall effect current transducer to measure the hot wire current. Consequently, the torch area of the weld system becomes quite crowded, and this may not allow the torch to enter tight areas when needed.

This second prior art system also only applies the hot wire voltage during application of the base or background current for the main welding arc in an attempt to eliminate the effects of magnetic disturbances or arc blow. However, this may not be the ideal situation for certain welding situations.

### SUMMARY OF THE INVENTION

In accordance with a broad aspect of the present invention there is provided a system for hot wire welding comprising a welding torch, means for forming a welding arc at the welding torch to provide a weld puddle, means for feeding a hot metal filler wire into the weld puddle at a specified speed, and means for continuously and automatically controlling current flow for heating the filler wire in response to change in the specified speed of the feed wire.

In accordance with a specific aspect of the present invention the controlling means controls (i) a current flow to the welding arc forming means, (ii) the filler wire feeding means to adjust the specified speed, and (iii) continuously controls a current flow for heating said filler wire in response to the specified speed of the filler wire. In a preferred embodiment of the invention, the controlling means is a digital computer.

In accordance with another broad aspect of the present invention there is provided a method of hot wire welding comprising the steps of forming a welding arc at a welding torch to provide a weld puddle, feeding a hot metal filler wire into the weld puddle at a specified speed; and controlling a current flow for heating the filler wire in a correlated response to change in the specified speed of the hot wire.

In accordance with another specific aspect of the present invention the controlling step controls (i) current flow to the welding arc, (ii) the filler wire to adjust the specified speed, and (iii) continuously, the current flow for heating the filler wire in response to the specified speed of said filler wire.

In accordance with yet another specific aspect of the invention, the step of and means for continuously controlling a current flow for heating the filler wire uses a low DC voltage in the range of greater than 0 volts to equal to or less than 20 volts, and preferably in the range of 10 to 12 volts. By using a low DC voltage, the effects of arc blow are minimized with an accurately controlled constant current power supply. As a result, the hot filler wire can be fed into the puddle in either the primary or background segments of the main weld current with no disturbance of the main weld arc. This feature avoids the prior art problem of applying the hot wire voltage only during the base or background current of the main welding arc in an attempt to eliminate the effects of magnetic disturbances or arc blow.

In accordance with an additional specific aspect of the invention, the step of and means for continuously controlling a current flow for heating the filler wire provides a data base of wire feed rate vs. hot wire current at specified percentage hot wire (HW) settings. One of several stored HW settings is selected for an intended hot wire weld. For example, a low HW setting of a percentage (typically 20%) of maximum current flow would be selected when performing a 360-degree full orbital welding.

Consequently, the hot wire welding method and system of the instant invention is easily controllable due to continuous and automatic control of hot wire supply current with reference to changes in the hot wire feed speed. This ensures an excellent control of the weld process regardless of changes in the wire feed and for 360-degree full orbital welding. The present invention is suitable for many forms of welding including, but not limited to Tungsten Inert Gas (TIG) Welding, Plasma Welding, Overlay systems, multiple hot wire systems, Narrow Groove Welding, Industrial machine stations, Seal buildup or knife edge buildup systems using the Dabber process, and for the replacement of Metal Inert Gas (MIG) weldings and in cross country pipeline welding systems.

The method and system of the instant invention eliminates the need for a complex current measuring and sensing circuitry such as required in the prior art system of FIG. 2 and its Hall effect current transducer in the torch area of the weld system. This is because the instant invention controls current flow for heating the filler wire in response to changes in the specified speed of the filler wire.

### BRIEF DESCRIPTION OF THE DRAWINGS

FIG. 1 depicts a block diagram of a prior art manually controllable hot wire welding system wherein a hot wire voltage is manually adjusted to match the wire feed rate;

FIG. 2 depicts a block diagram of another prior art hot wire welding system, which includes a complex arrangement of measuring and sensing circuitry for measuring the hot wire voltage and current and for operating a gate thyristor to turn on and off the hot wire supply voltage;

FIG. 3 shows a block diagram of a hot wire welding system in accordance with the present invention which provides a novel and easily controllable system;

FIGS. 4A-4F are schematic drawings of a hot wire control circuitry embodiment of the present invention within the controlling power source;

FIG. 5 is a flow chart diagram showing an embodiment of the logic in accordance with the present invention for calculating control signals in the hot wire weld system;

FIG. 6 is a flow chart diagram showing an embodiment of the logic in accordance with the present invention for going from one welding segment to another and for controlling the hot wire process with a capability for 360-degree full orbital hot wire welding;

FIG. 7 is a flow chart diagram showing an embodiment of the logic in accordance with the present invention for a wire delay routine which allows the operator to successfully form a main weld puddle before the hot wire is introduced;

FIG. 8 is a flow chart diagram showing an embodiment of the logic in accordance with the present invention for a wire slope routine which allows for sloping or slowing increasing or decreasing the amount of hot wire fed into the main weld puddle when starting or ending a weld cycle;

FIG. 9 is a flow chart diagram showing an embodiment of the logic in accordance with the present invention for a wire override routine for on the fly changes in hot wire, wire feed speed and current control which allows an operator to change welding parameters on the fly with no disturbance of the hot wire process; and

FIG. 10 is a graph showing wire feed rate plotted against hot wire current at specified percentage hot wire settings, which information is stored as a data-base in a memory unit of a microprocessor shown in the hot wire welding system of FIG. 3.

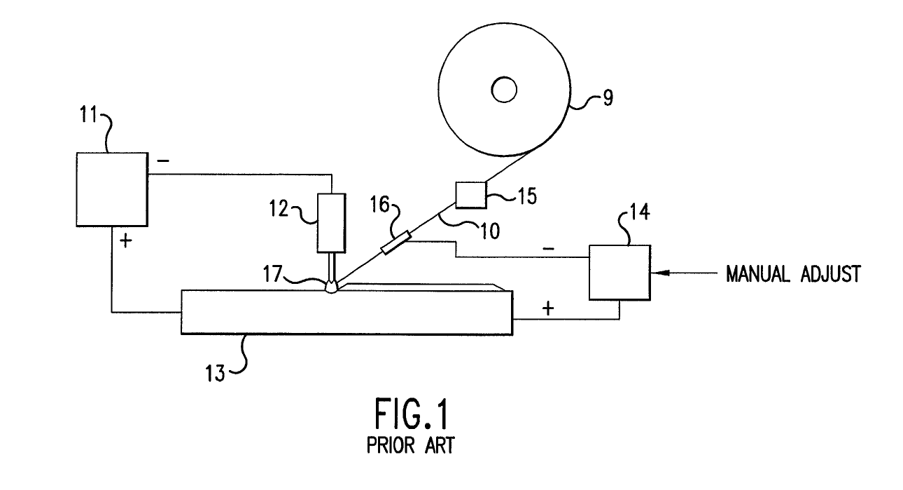

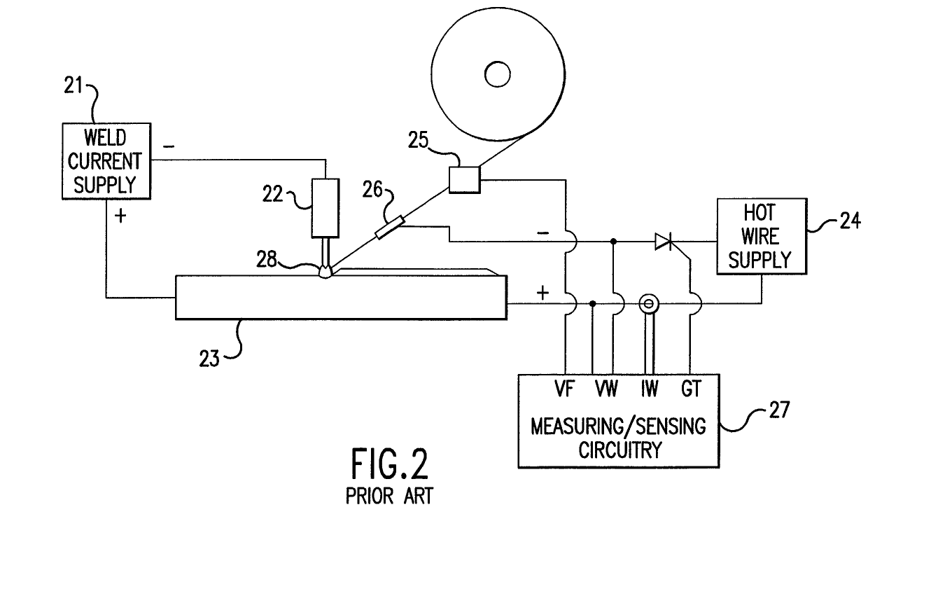

### DESCRIPTION OF SPECIFIC EMBODIMENTS

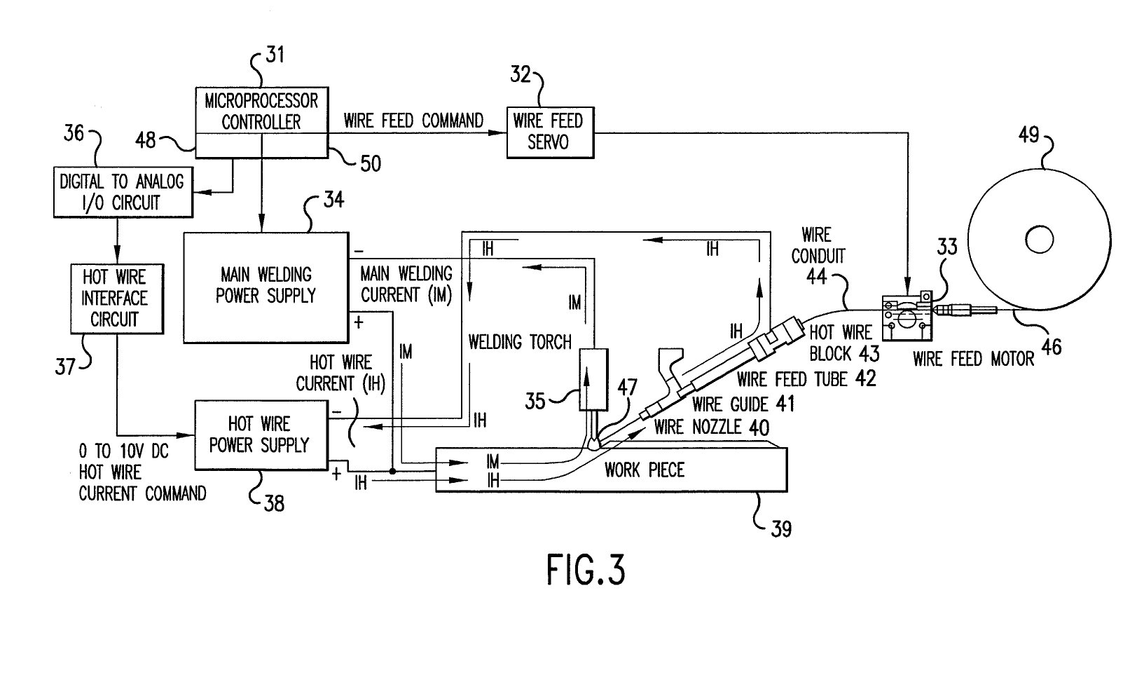

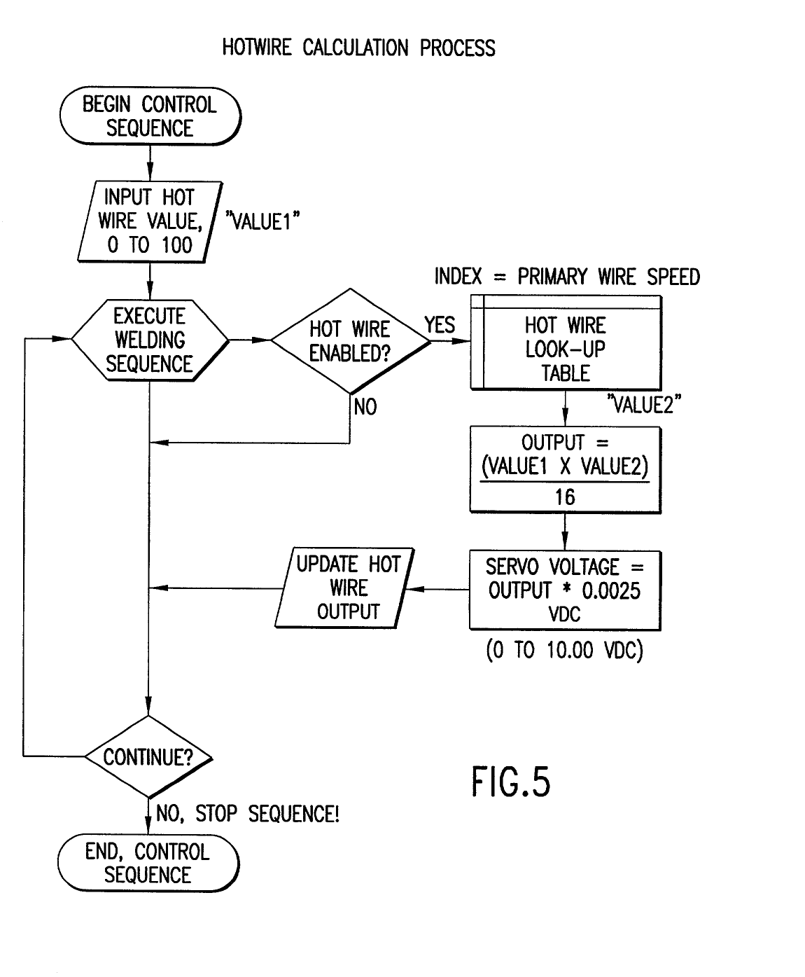

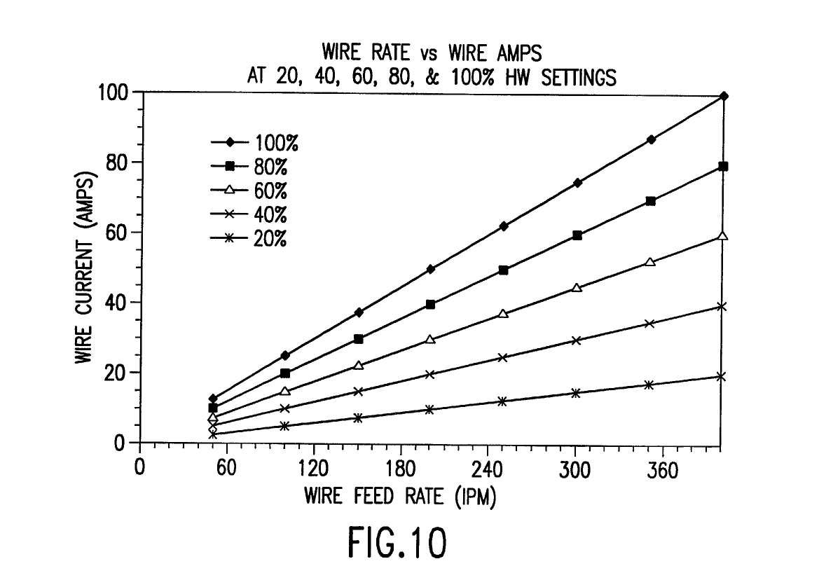

FIG. 3 is a block diagram of an embodiment of the present invention which provides simplified and easily overridden hot wire control. With reference to FIG. 3, digital computer means embodied as a microprocessor controller 31 is provided for controlling all aspects of the welding process. The microprocessor controller 31 comprises a central processing Unit (CPU) 48 for processing or running at least the logic routines provided in FIGS. 5 to 9, and a memory unit 50 for storing information including the data of FIG. 10 as a data-base. The CPU unit can include an Intel 8032 chip.

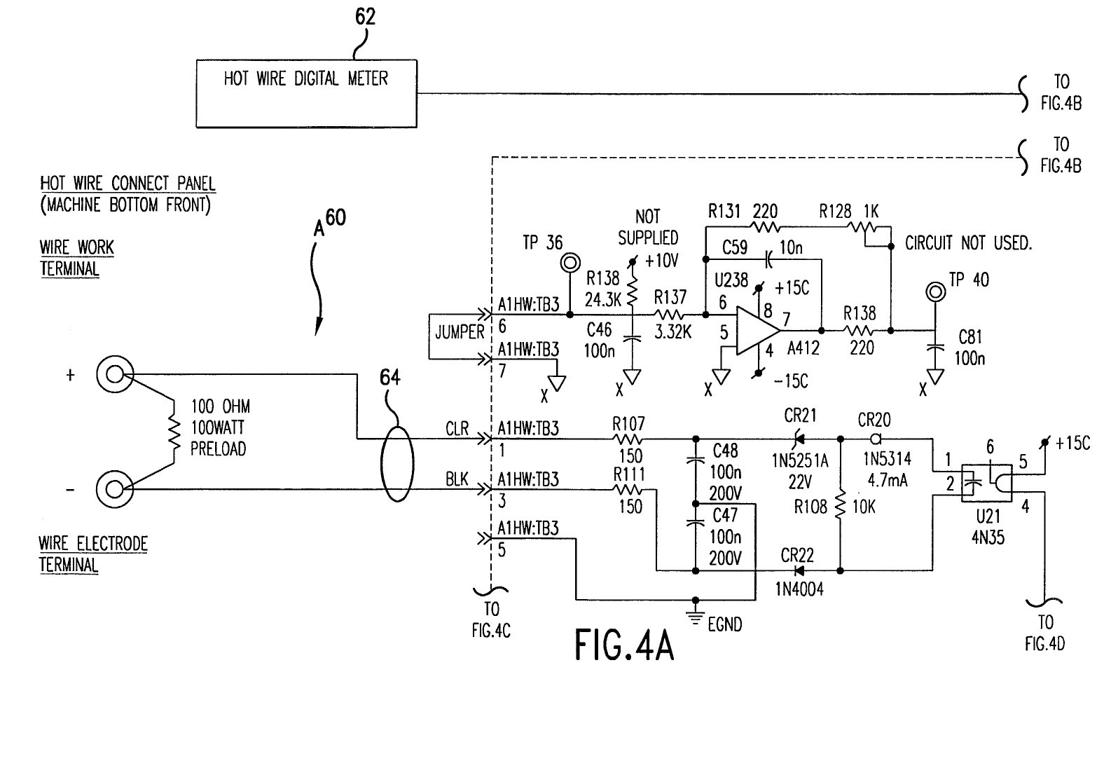

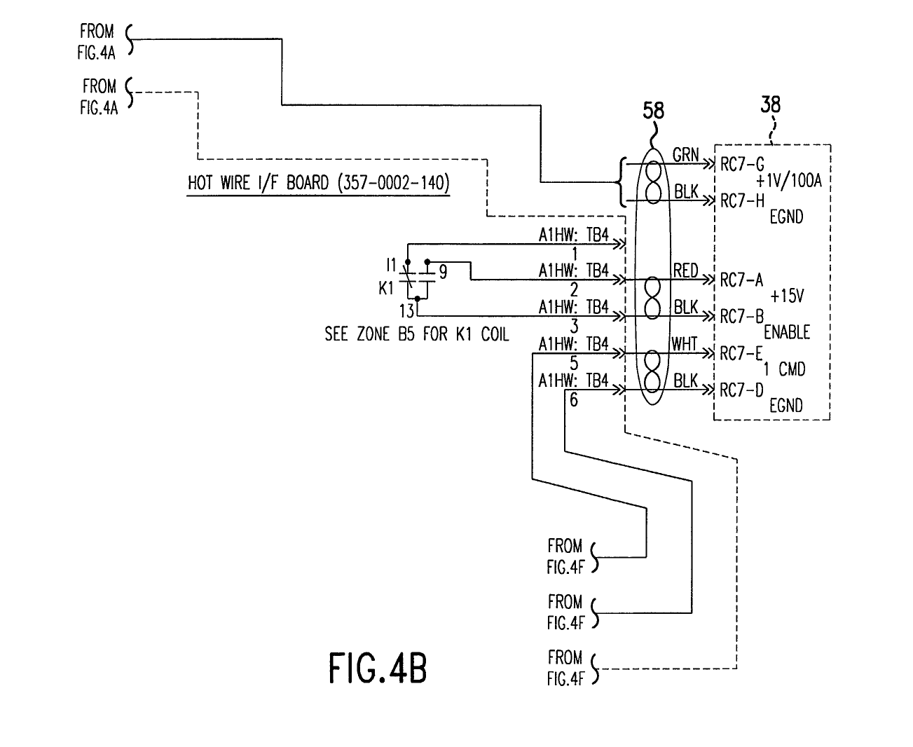

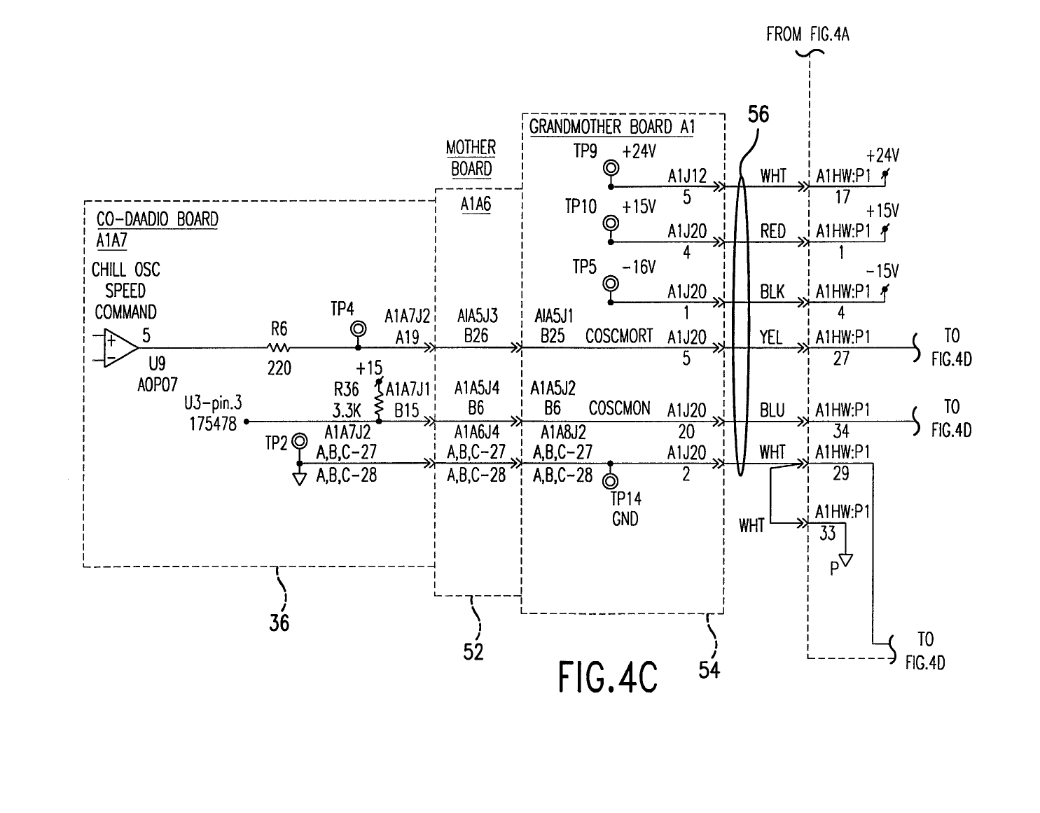

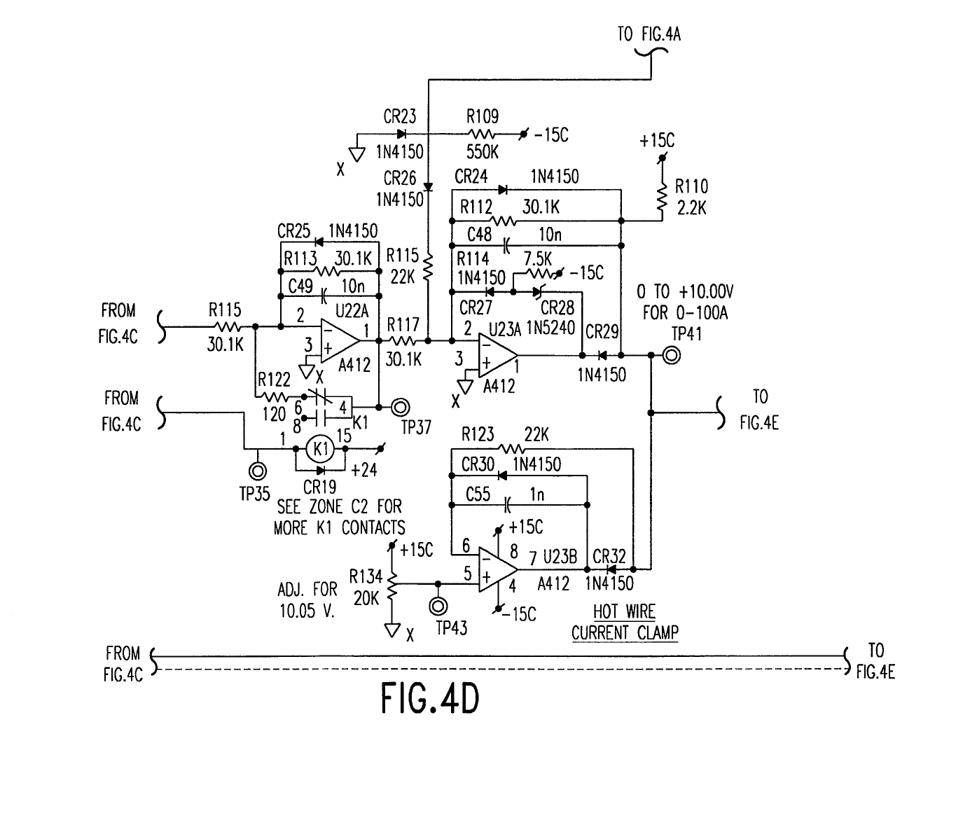

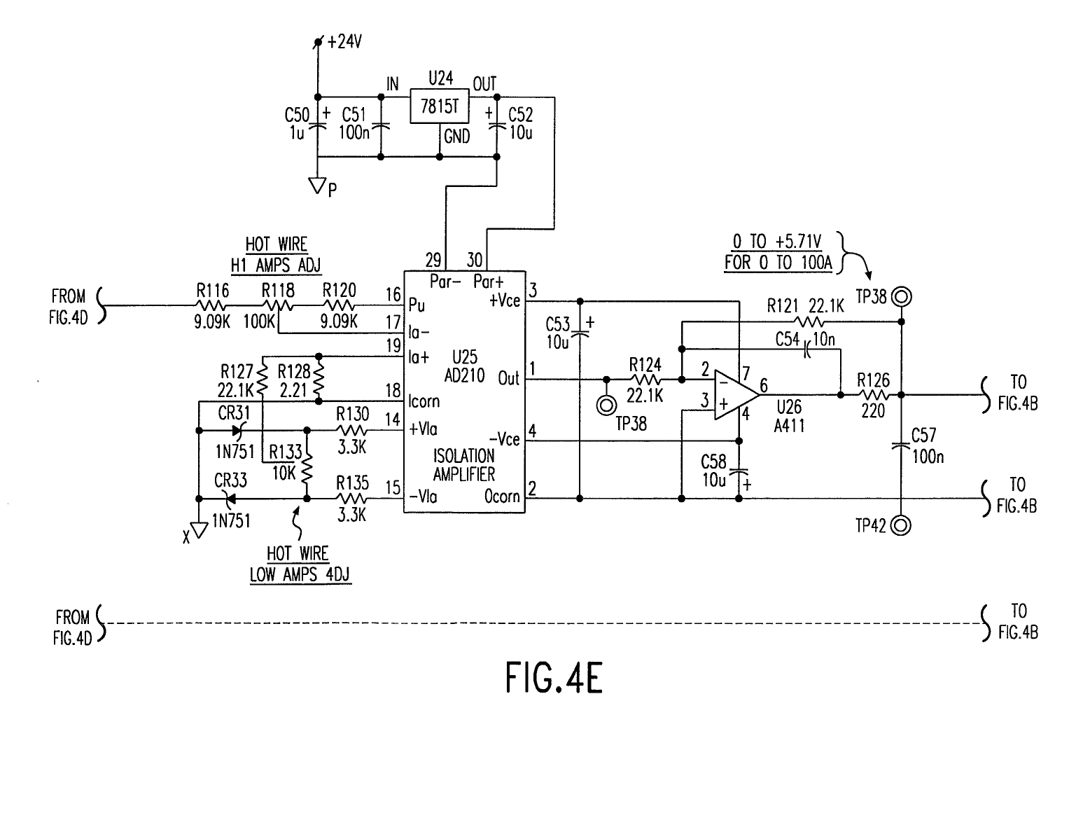

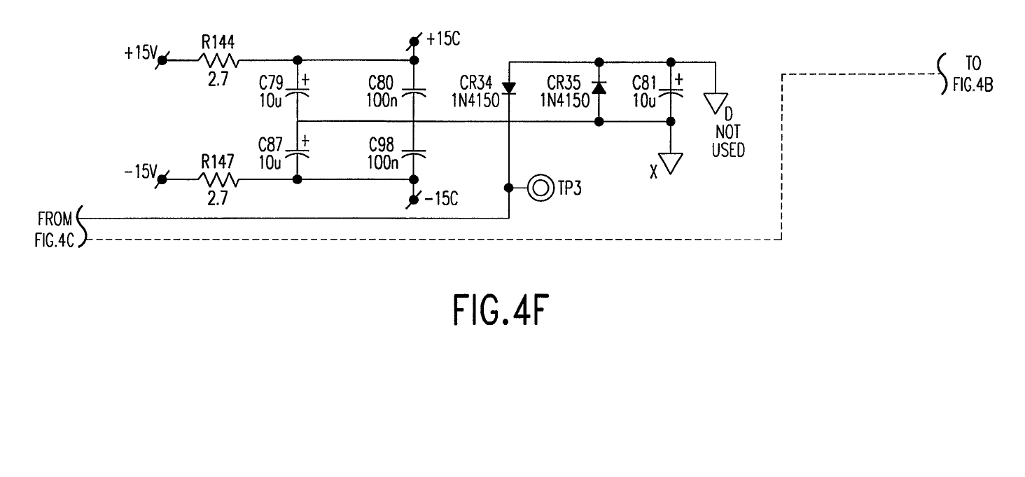

A wire feed servo 32 is directed by the microprocessor controller 31 to maintain a desired filler wire speed. A wire feed motor 33 feeds the filler wire 46 into a welding puddle 47. This system also contains a main welding power supply 34 for supplying a main welding current to a torch 35 which preferably includes a non-melting tungsten electrode. The main welding power supply 34 is preferably a DC source. A digital to analog output circuit 36 converts the digital control output of the microprocessor 31 to an analog signal. A hot wire power supply interface circuit 37 (shown in detail in FIG. 4) further amplifies the hot wire control signal and isolates it for protection from outside noise. This is a 0 to 10 VDC control signal that is then routed to a hot wire power supply 38, which in turn conducts the hot wire supply current to a hot wire contact block 43. From here the filler wire 46 travels through an insulted wire feed tube 42, and is fed into the weld puddle 47 at a desired angle of entry by a wire guide 41. A wire nozzle 40 is used to accurately deploy the wire 46 into the weld puddle 47 created by the main welding power supply 34. A work piece or ground 39 is the return path for both the main welding power supply 34 and the hot wire power supply 38. With the microprocessor controller 31, an operator can enter, override, change on the fly, slope and fully adjust the wire feed speed while the amount of hot wire current supplied to the filler wire is automatically controlled. The microprocessor controller 31 automatically controls the amount of hot wire current supplied to the filler wire with changes in the speed of the filler wire. Because the system in accordance with the present invention is designed to be a constant current source and does not attempt to maintain a constant voltage as in the prior art, several of the obstacles limiting the prior art are overcome.

In this embodiment of the invention, the amount of current in the filler wire 46 is dependant on two programmable parameters and one physical one. The two programmable parameters are wire feed rate and hot wire value. The physical parameter is the resulting voltage between the welding workpiece 39 and the electrical coupling of the hot wire block 43 of the wire conduit 44. This voltage is the product of the current in the filler wire 46 times the resistance of the wire portion that is between the electrical coupling 43 on the conduit 44 and the workpiece 39. An additional important point is that the wire 46 must be fed directly into the weld puddle 47. Otherwise an electric arc will develop between the end of the wire 46 and the weld puddle 47 (assuming the wire did touch the work in the first place to start current flowing).

Thus, the instant invention provides a constant current supply, rather than constant voltage as in prior art. As a result, there is nothing to regulate the arc voltage if something hinders the wire delivery mechanism (or the wire on the spool 49 runs out). If this happens, the arc can easily rise up into the wire nozzle to cause a need to shut down. To solve this problem, this embodiment of the present invention includes a voltage clamping circuit (shown in FIG. 4) to limit the current if more than a predetermined voltage (e.g., 20 VDC) is at the output terminal of the Hot Wire Connect Panel (FIG. 4).

With reference to FIG. 4, both the analog and digital commands to the Hot Wire Power Source 38 originate from the digital to analog output circuit (DAC) 36 shown as a Co-Daadio board. The analog value is a 0 to 10 vdc signal corresponding to wire speed commands of 0 to 400 IPM (assuming that the Percent of Hot Wire parameter is set for 100%). This analog signal is available at TP4 and TP2 (common). The TP4 signal makes it way to the Hot Wire Interface circuit or board 37 by the following connections: A7J2,A19 (Co-Daadio board 36 to mother board 52) to A6J1,B28 (mother board 52 to grandmother board 54) and A1P20-5 to HWP1-27 (grandmother board 54 to the Hot Wire Interface circuit 37 or board by a cable 56).

The digital signal to enable the hot wire power supply 38 is turned on whenever the wire feeder 33 is energized. “Turned on” means that pin 3 of U3 in the DAC 36 goes low which sinks the 24 vdc circuit applied to relay K1 on the Hot Wire Interface board 37. Pin 30 of U3 connects from the DCA 36 to the Hot Wire Interface board 37 by way of these connections: A7J2,B16 (DCA 36 to mother board 52) to A6J2,B6 (mother board 52 to grandmother board 54) and A1P20-20 to HWP1-34 (grandmother board 54 to Hot Wire Interface board 37 by cable 56). The signal side of relay K1 (same point as pin 3 of U3) is available at TP 35 (common is TP3).

The Hot Wire Interface Board 37 contains circuitry to condition both the analog and digital signals to the hot wire power supply 38.

The digital signal is present at the contacts of relay K1. These are the normally open contacts that connect to TB4 pins 2 and 3. Pin 2 connects to a Miller RC7-A in which case is the Miller is at +15 volts. Pin 3 connects to Miller pin B which is its Enable signal. These connections are made through a cable 58 interconnecting the Hot Wire Interface circuit or board 37 and the hot wire power supply 38.

The analog command to the Miller is a little more complex. The analog command that comes into HWP1-27 is referenced to common on HWP1-29 and 33. This is the same as is present at TP3. This command is buffered and inverted with U22A.

A voltage clamp circuit 60 drives the current command to the Hot Wire Power supply 38 to 0 if it detects that the voltage on the output terminals is higher than 20 vdc. The voltage sensing leads for this circuit connect to TB3-1 (+) and TB3-3 (−). When this voltage rises above 20 volts, optocoupler U21 turns on and provides +15 v to the input of U23 thereby swamping out the analog command coming from U22A. The result of these two conditions goes through another buffer/inverter (U23A). Its output is present at TP41 (common still on TP3).

In parallel with U23A is U23B. Its function is a hardware clamp so the voltage on TP41 does not go above the pot setting of R134 (TP43). Typically this is set for 10.00 volts.

The voltage at TP41 goes through the linear isolation amplifier U25. This is designed for power sources where isolation is required. Isolation is not really required for the GT5 controller to the Hot Wire Power supply circuit or board 38 because on both, the dc common is also frame ground. However the associated max. (R118) and min. (R135) trim pots on the GT5 side of the isolator serve as a handy way to scale the voltage for the actual current command to the Hot Wire Power Supply circuit or board 38. The isolated analog command is + (plus) on TP38 and − (minus) on TP42. These points go to the Hot Wire Power Supply circuit rear panel connector by way of cable 58 [TB4-5 to RC8-E (+) and TB4-6 to RC8-D (−)].

The Hot Wire Supply circuit 38 for supplying the power to heat the filler wire 46 is suitably a Miller MaxStar 175 (MaxStar is a registered trademark of Miller Electric Mfg. Co.). This unit works well with the GT5 systems because both require 460 volt, 3 phase power. The power for the MaxStar 175 is supplied from the main rotary power switch on the front panel of the GT5 by three, 10 gage, black wires to three fuse holders on the lower portion of the rear panel.

The front panel switch settings on the MaxStar 175 must be set as follows for the unit to function properly in the GT5 Hot Wire System. A cover panel is installed over the settings to minimize wrong switch positions. The following gives the correct switch settings:

(1) Power Switch—On—(note that the pilot light is on).

(2) Amperage Control Switch—In the remote amp position (towards the arrow).

(3) Output Contactor Switch—In the remote position (towards the arrow).

(4) Weld Process Switch—IN the GTAW position.

(5) Arc Lift Switch—In the OFF position.

(6) The Amperage dial is not active, but should be left set for the minimum amperage position.

A digital meter 62 is provided for displaying the Hot Wire Amps. It is a 0-20 volt meter set up to display 100 for 1.00 volt input.

On the inside of the Hot Wire Connect Panel is a 100 ohm, 100 watt power resistor 66, which is used to preload the Hot Wire Supply circuit 38 as soon as it is enabled (at the start of wire feed). The resistor lowers the open circuit voltage of the Hot Wire Supply circuit 38 from the 95 to 105 volt range to the 40 to 45 volt range. This minimizes sparking between the wire and the workpiece as well as reduces hazardous voltage at the weldhead for operator safety.

Cable 56 between the grandmother board 54 and the Hot Wire interface board 37 supplies +5 v,+/−15 v,+24 v, to the Hot Wire board 37 as well as the analog current command and the digital enable for the Hot Wire Power Supply 38.

Cable 58 is connected between the Hot Wire Power Supply 38 and the Hot Wire interface board 37 and the Hot Wire Digital meter 62. This cable 58 connects the enable and current amplitude command from the Hot Wire interface board 37 to the Hot Wire Power Supply 38. It also connects the current feedback signal from the Hot Wire interface board 37 to the digital meter 62 for the Hot Wire Amps display.

Cable 64 interconnects the Hot Wire Connect panel output terminals and the Hot Wire interface board 37 to provide the output voltage of the Hot Wire Power Supply 38 to the Hot Wire interface board. As discussed above, if the Hot Wire Power Supply 38 has more than 20 volts on its output terminals, the Hot Wire interface board will drop the current command signal to the Hot Wire Power Supply 38 to 0 volts.

With reference to FIG. 5, there is provided a flow chart diagram showing an embodiment of the logic in accordance with the present invention for calculating control signals in the hot wire weld system. The microprocessor controller 31 in the system, scales the current command to the hot wire supply 38 based on both of the programmable settings of wire feed rate and hot wire value. If the Percent of Hot Wire is 100%, then the current command will range from 0 to 100 amps corresponding to 0 to 400 IPM of wire feed rate as shown in the graph of FIG. 10. In other words, a command of 100 IPM commands 25 amps, 200 IPM commands 50 amps, 300 IPM commands 75 amps and 400 IPM commands 100 amps.

Similarly, if the Percent of Hot Wire is 50% then the current command will range from 0 to 50 amps corresponding to 0 to 400 IPM of wire feed rate. In this case a command of 100 IPM commands 12.5 amps, 200 IPM commands 25 amps, 300 IPM commands 37.5 amps and 400 IPM commands 50 amps. As noted above, the information of the chart in FIG. 10 is stored as a data-base in the memory unit 50 of the microprocessor unit 31 to provide a basis for determining the commanded wire current for specified settings of Wire Feed Rate and Percent of Hot Wire. Depending on the resistance of the filler wire (combination of the wire diameter and material) the voltage clamping circuit (FIG. 4) will limit the current command to the hot wire supply 38.

The location of the electrical coupling on the wire conduit 44 also is involved. Several tests were preformed to determine the best location of the electrical coupling to allow enough hot wire current, but also control wire burn-back if wire delivery is impeded.

With 0.035″ diameter wire, a setting of 50 for the Percent of Hot Wire works well. A feed rate of 100 IPM gives 12.5 amps, 200 IPM gives 25 amps, 300 IPM gives 37.5 amps, but 400 IPM may or may not give 50 amps. It depends heavily on how well the end of the wire stays in the weld puddle. For example, 50 amps on 0.035″ wire may preheat the wire so much that the wire liquefies and just drips into the puddle. Between drips, an arc forms between the wire and the puddle; this causes the voltage to rise above the 24 VDC limit, thus reducing the current command to the hot wire power supply 38. This may be known as MIG-ing, since the wire is burning off from an arc drawn between it and the work. However, most MIG welding systems use a constant voltage type power source.

If the Percent of Hot Wire is raised to 100% for the preceding situation, the following can be expected: a feed rate of 100 IPM to yield 25 amps, 200 IPM to yield 45-50 amps, 300 IPM to yield 45-50 amps, and 400 IPM to yield 45-50 amps. Again, the physical limits of the resistance of the wire, the location of the electrical coupling and the voltage limiting circuit limit the maximum current into the wire to the 45-50 amp range.

If 0.045″ wire is used with a Percent of Hot Wire value of 100%, the results are similar to the following: a feed rate of 100 IPM gives 25 amps, 200 IPM gives 50 amps, 300 IPM gives 75 amps, but 400 IPM most likely will not give 100 amps. It would probably be around 85-90 amps for the same reasons as stated above.

Based on tests using 0.035″ wire, good welding was obtained at 330 IPM at 50% on the Hot Wire setting. The resulting hot wire amps was 40-41 amps. For 0.045″ wire, good results were obtained at 330 IPM at 80%. This resulted in 66 amps of hot wire current flow.

The formula used to determine the commanded current from the hot wire power supply is:

I=(R/4)(V/100)

where R=Wire Feed Rate, and

V=Hot Wire Percent Value.

For example, a Wire Feed Rate of 330 IPM at a Hot Wire Percent Value of 80% would have a commanded current determined by:

(330/4)(80/100)=66 amps.

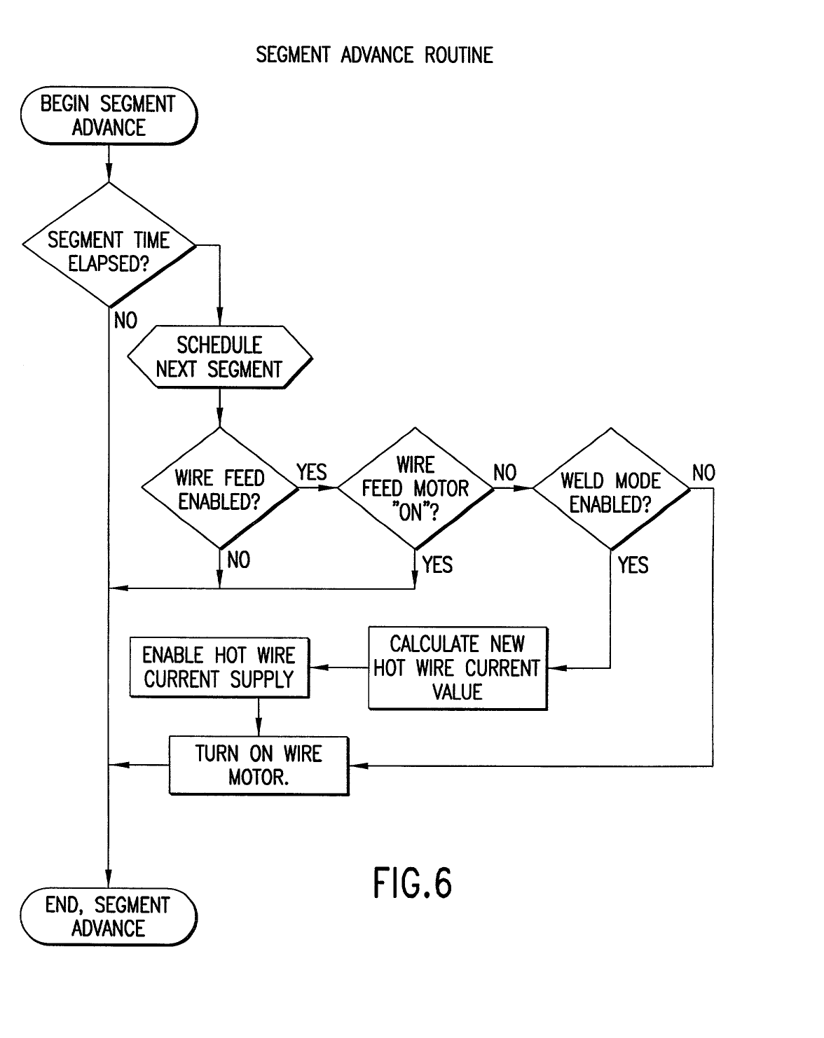

The instant invention provides a hot wire welding method and system that is fully changeable and controllable for many different welding necessities. FIG. 6 shows the logic flow pattern of the hot wire for different weld segments or sections. The entire welding cycle can be broken down into various stages. There is the arc ignition stage, initial current, puddle development stage or upslope, main weld, downslope and finally arc extinguishment. The portion of the main weld can be broken up into many different segments as well. Due to part heating, changes in the weld joint, or for doing 360 degree orbital welding many different segments may be needed for a single weld program. The present invention provides for this feature with hot wire. The logic of FIG. 6 is executed as one segment ends and another begins. The microprocessor controller 31 calculates the new hot wire current value with the change of wire feed speed in the new segment. As the logic diagram shows, the hot wire could even be turned off if needed and restarted within a segment or the next one. This feature is not available with the prior art embodiments.

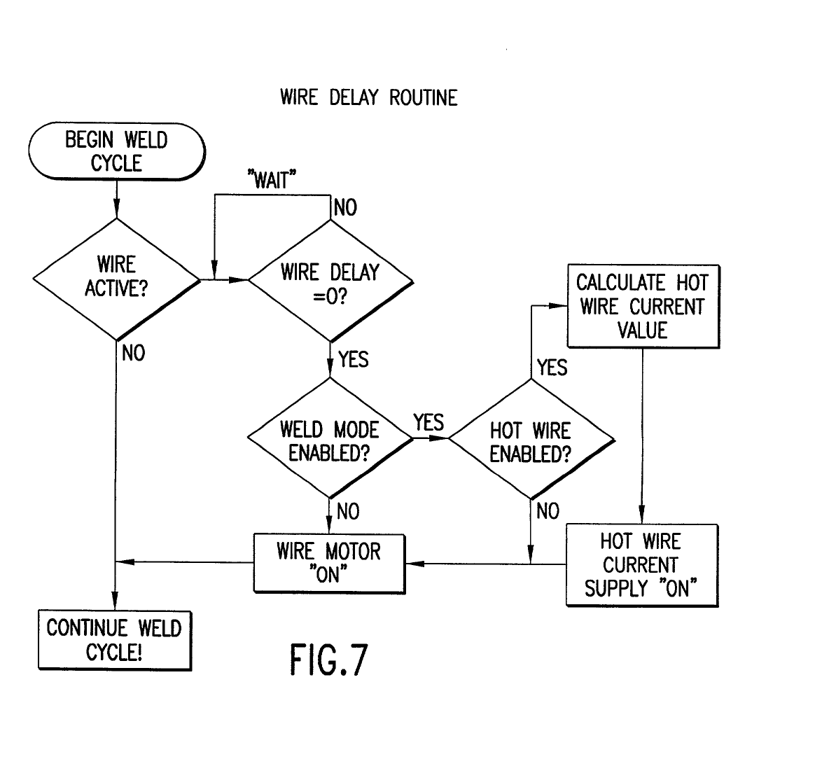

With reference to FIG. 7, there is shown a wire delay routine in which the wire can be delayed before coming on by some amount of time selected by the operator. This allows the main welding arc to be initiated and a weld puddle to form before wire is introduced into the puddle.

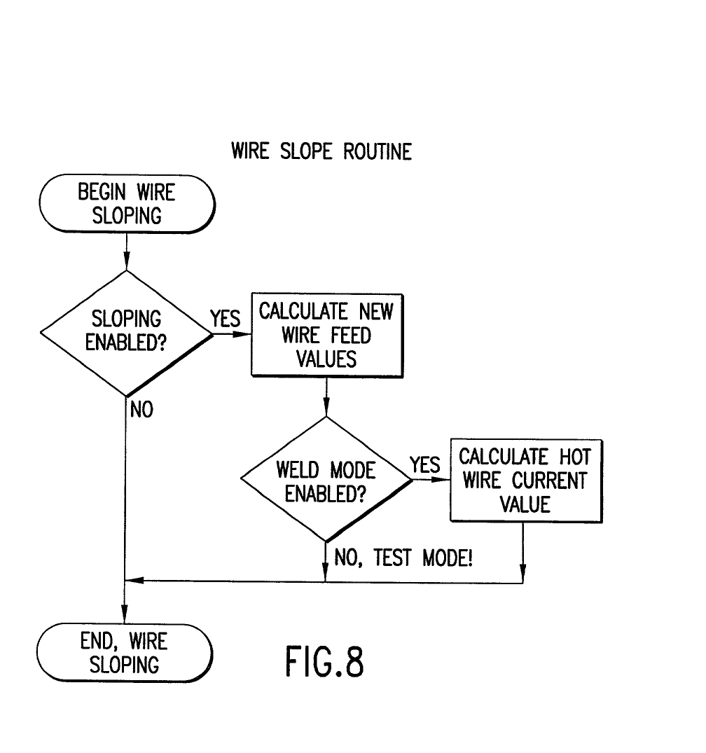

FIG. 8 is a flow chart diagram showing an embodiment of the logic in accordance with the present invention for a wire slope routine in which the wire speed can be slowly increased to the full desired speed as a new weld is started. Once a new weld has been initiated and the wire delay routine is complete, the hot wire is slowly inserted into the weld puddle as the main weld begins. This produces a nice tapered weld bead. The opposite is also true. As the weld is slowly tapered out or downsloped, the wire speed is slowly decreased or sloped. The microprocessor controller 31 automatically adjusts the hot wire current for either situation and produces a very clean good weld at the beginning and end of the welding puddle.

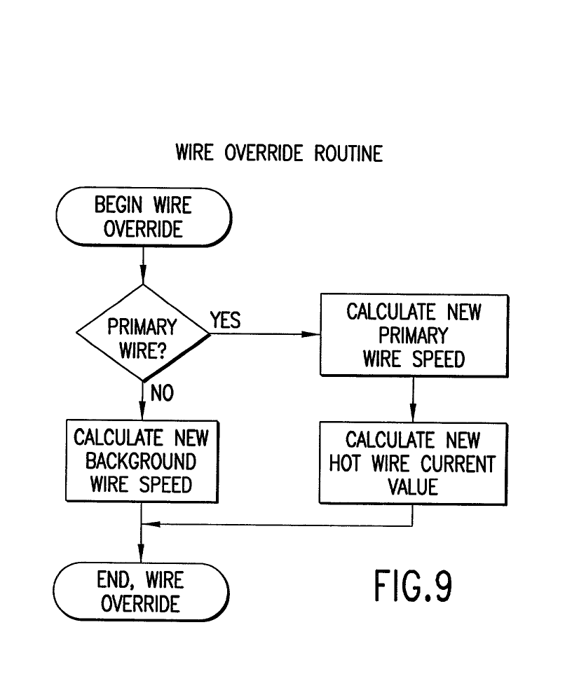

With reference to FIG. 9, there is shown a wire override routine, which allows for changing of the wire during a weld. Very often, it is necessary to adjust the wire feed rate during the welding process. This is referred to changing on the fly. As the operator requests an increase or decrease in the wire feed speed, the microprocessor controller 31 automatically adjusts the hot wire supply current to match the changing of the wire speed. This allows for smooth, flawless operation of the hot wire current in relationship to the new wire feed rate.

### System Operation

Thus the present invention provides a hot wire welding system which includes the welding torch 35 (preferably with a non-melting tungsten electrode), the melting metal filler wire 46 which is fed into the weld puddle 47 created by the welding arc 35, the microprocessor controller 31 for controlling (i) the current of the main welding arc, (ii) the filler wire feed speed, and (iii) the hot wire current control for heating of the hot wire. A main welding power supply 34 is provided for supplying the main welding arc, and a hot wire power supply 38 is provided for supplying a secondary DC supply to the hot wire current. By use of the microprocessor controller 31 and the fact that all controls are routed through it, prior art manual override and clumsy manipulation of the hot wire supply current is avoided. Also eliminated is the prior art need for complex control circuitry and measuring sensors and circuitry at the torch. The hot wire current is automatically controlled by the microprocessor controller to supply the correct amount of hot wire current to the filler wire 46 with changes in wire feed speed. As the wire feed rate is increased, the hot wire current is automatically increased to maintain proper melting of the filler wire 46 into the weld puddle 47. A significant reduction in the complexity of operating the system is obtained along with an increase in the high degree of accuracy of the weld, with less heat input and distortion into the part.

A simplistic design and approach at the power supply allows for smaller components at the main welding torch and wire feed system. This in turn allows the torch to reach into smaller areas not other wise suitable for hot wire welding, and not found with the prior art.

Also, control over the amount of hot wire supply current is fully adjustable from 0 to 100% of the rated output. This control permits more flexibility in the welding process by eliminating possible over current situations by less experienced operators.

The method and system for hot wire welding in accordance with the instant invention provides the following additional advantages over the prior art. First, the system of the invention uses a secondary inexpensive DC constant current power supply, and interface circuit for the addition of the hot wire welding system. This enables an inexpensive upgrade of non-hot wire systems into systems that are able to perform hot wire welding. Furthermore, the use of the microprocessor controller allows for a high degree of accuracy in the weld itself. By accurately controlling the amount of hot wire current supplied to the filler wire, in reference to the speed of the filler wire, a high degree of accuracy can be obtained in the weld. Also such control provides for the ability to slope, override, delay, turn on and off, and fully adjust the hot wire parameters along with the various segments within a weld cycle.

Also, the method and system for hot wire welding in accordance with the instant invention provides for many different applications of welding including full 360 degree orbital welds with X-Ray quality, Plasma welding with hot wire, Overlay welding with single or multiple hot wires, Narrow Groove Welding, Seal or Knife edge Welding by use of the Dabber System, Pipe Welding Systems, Industrial Automated Stations, and as a replacement to MIG welding systems. These methods and systems have been run with excellent results especially in the overlay and pipe welding systems. The ability to perform an open root weld, with no backing plate, using hot wire was successfully preformed with ease using the method and system of the instant invention. Multiple hot wires (2 or 3 or more) have been preformed for cladding and overlay systems with equally excellent welding results. The ability to do this provides less heat input into the part being welded, less stress in the welded joint, and less distortion of the part, with much higher wire deposition rates than previous welding systems would allow.

The invention stated here has been described with specific details. It is to be noted here the described details are illustrative of the hot wire welding method and system and that changes and modifications along with the addition of multiple hot wires may be implied without deviating from the intent of this invention which is limited by the appended claims.

What is claimed is:

1. A system for hot wire welding comprising:
a welding torch;
means for forming a welding arc at said welding torch to provide a weld puddle;
means for feeding a hot metal filler wire into said weld puddle at a specified speed; and
means for continuously controlling a current flow for heating said filler wire in response to said specified speed of said hot wire.

2. A system for hot wire welding comprising:
a welding torch;
means for forming a welding arc at said welding torch to provide a weld puddle;
means for feeding a hot metal filler wire into said weld puddle at a specified speed;
means for heating said filler wire; and
means (i) for controlling a current flow to said welding arc forming means, (ii) for controlling said filler wire feeding means to adjust said specified speed, and (iii) for continuously controlling said heating means to provide a current flow for heating said filler wire in response to said specified speed of said hot wire.

3. The system of claim 2 further comprising a first power supply for supplying the current flow to said welding arc forming means, and a second power supply for supplying the current flow for heating said filler wire.

4. The system of claim 3 wherein said first power supply is a DC power source.

5. The system of claim 3 wherein said second power supply is a DC power source.

6. The system of claim 3 wherein said controlling means comprises a microprocessor controller.

7. The system of claim 6 wherein said microprocessor controller controls the current flow for heating said filler wire in response to changes in wire feed speed.

8. The system of claim 5 wherein said second power supply includes a voltage clamping circuit on an output thereof.

9. The system of claim 8 wherein said voltage clamping circuit aids in preventing excessive arc interference the limiting of the voltage for said hot wire, whereby burn back of said hot wire is prevented.

10. The system of claim 1 wherein said controlling means is a digital computer.

11. The system of claim 1 wherein said controlling means includes a data base of wire feed rate versus hot wire current at a plurality of percentage hot wire (HW) settings, and wherein a HW setting is selected to provide a percentage of maximum current flow for heating said filler wire.

12. The system of claim 1 wherein said controlling means controls a DC output voltage of said heating means in a range of greater than 0 volts and equal to or less than 20 volts to provide a current flow to heat said filler wire.

13. The system of claim 12 wherein said DC output: voltage of said heating means is in the range of 10 to 12 volts.

14. A method of hot wire welding comprising the steps of:
forming a welding arc at a welding torch to provide a weld puddle;
feeding a metal filler wire into said weld puddle at a specified speed while said filler wire is heated; and
continuously controlling a current flow for heating said filler wire in response to changes in said specified speed of said filler wire.

15. A method of hot wire welding comprising the steps of:
forming a welding arc at a welding torch to provide a weld puddle;
feeding a hot metal filler wire into said weld puddle at a specified speed while said filler wire is heated; and
with a digital computer (i) controlling a first current flow to said welding arc forming means, (ii) adjusting said specified speed, and (iii) continuously controlling a second current flow for heating said filler wire in response to said specified speed of said filler wire.

16. The method of claim 15 further comprising the steps of supplying said first current flow to said welding arc from a first power supply, and supplying said second current flow for heating said filler wire from a second power supply.

17. The method of claim 16 wherein said first power supply is a DC power source.

18. The method of claim 16 wherein said second power supply is a DC power source.

19. The method of claim 15 further comprising the steps of preventing excessive arc interference by limiting filler wire voltage.

20. The method of claim 15 wherein said digital computer includes a data base of wire feed rate versus hot wire current at a plurality of percentage hot wire (HW) settings, and wherein said method further comprises the step of using said digital computer to select a HW setting to provide a percentage of maximum current flow for heating said filler wire.

21. A computer-readable medium having computer-executable instructions for performing the steps of any of claims 14, 15, 16, 19 or 20.

22. A computer-readable medium having stored thereon a data structure relating wire feed rates versus hot wire current at a plurality of percentage hot wire settings as shown in FIG. 10.

23. A system for hot wire welding comprising:
a welding torch;
a welding power supply for supplying power to said welding torch for forming a welding arc at said torch to provide a weld puddle;
a filler wire supply mechanism for feeding a metal filler wire heated by electrical current into said weld puddle at a specified speed; and
a controller for continuously controlling current flow for heating said filler wire in response to said specified speed of said hot wire.

24. The system of claim 23 wherein said controller is a digital computer.

25. The system of claim 23 wherein said controller includes a memory storing a data base of wire feed rate versus hot wire current at a plurality of percentage hot wire (HW) settings, and wherein said controller selects a HW setting to provide a percentage of maximum current flow for heating said filler wire.

26. The system of claim 23 further comprising a DC power supply for providing Dc power for heating the filler wire, and wherein said controller controls a DC output voltage of said DC power supply in a range of greater than 0 volts and equal to or less than 20 volts to provide said current flow to heat the filler wire.

27. The system of claim 26 wherein said DC output voltage is in the range of 10 to 12 volts.

28. A system for hot wire welding comprising:
a welding torch;
a first power supply supplying power to said welding arc at said torch to provide a weld puddle;
a filler wire supply for feeding a metal filler wire heated by electrical current into said weld puddle at a specified speed;
a second power supply for supplying said electrical current for heating said filler wire; and
a controller, said controller (i) controlling a current flow from said power supply means to said welding torch, (ii) controlling said filler wire supply to adjust said specified speed, and (iii) continuously controlling said current supply to provide current flow for heating said filler wire in response to said specified speed of said hot wire.

29. The system of claim 28 wherein said first power supply is a DC power source, and said second power supply is a DC power source.

30. The system of claim 28 wherein said controller comprises a microprocessor controller.

31. The system of claim 30 wherein said microprocessor controls said current flow for heating the filler wire in response to changes in wire feed speed.

32. The system of claim 29 wherein said second power supply includes a voltage clamping circuit on an output thereof, said voltage clamping circuit preventing excessive arc interference by limiting voltage, whereby burn back of the filler wire is prevented.
